(19) United States
(12) Patent Application Publication
(10) Pub. No.: US 2017/0145746 A1
(43) Pub. Date: May 25, 2017

(54) LADDERS AND METHODS FOR ASSEMBLING LADDERS

(71) Applicant: Caterpillar Inc., Peoria, IL (US)

(72) Inventors: Thomas A. Meyen, Clinton, IL (US); Charles T. Hudson, Decatur, IL (US); Riley A. Albers, Decatur, IL (US); Jared E. Louis, Monticello, IL (US)

(73) Assignee: Caterpillar Inc., Peoria, IL (US)

(21) Appl. No.: 14/945,750

(22) Filed: Nov. 19, 2015

(51) Int. Cl. E06C 5/04

(52) U.S. Cl. CPC E06C 5/04

(57) ABSTRACT

Ladders and methods for assembling ladders are disclosed herein. A disclosed example ladder includes a mount, a frame including a step, an aperture defined in at least one of the mount and the frame, a lug positioned in the aperture to pivotably and translatably connect the mount and the frame, and a plate. The disclosed ladder also includes a saddle positioned to engage the plate to releasably secure the frame to the mount. The frame can, thus, be displaced from the mount in response to a force to avoid breakage.

### TECHNICAL FIELD

This disclosure relates generally to ladders and methods for assembling ladders.

### BACKGROUND

Heavy machinery vehicles (e.g., mobile equipment such as mining vehicles, construction equipment, farming equipment, trucks, utility vehicles, steel factory equipment and/or the like) sometimes have one or more externally mounted ladders to provide access to areas (e.g., a cab) that are located at a substantial vertical height above the ground. Such a ladder must have sufficient rigidity and strength to withstand the weight of a person.

To service a person standing on the ground, such ladders often exhibit a relatively low clearance from the ground. Due to this relatively low clearance, such ladders can sometimes collide with a berm, debris, rocks, dirt, or other object on the ground as the vehicles moves (e.g., within a construction or mining site, on a road side, in a field, etc.). Such a collision can result in damage and/or loss of the ladder.

A known foldable ladder for a pickup truck is shown in International Patent Application Publication No. WO2014062100. This known foldable ladder is used for accessing a cab of a commercial vehicle. The ladder is attached to a bed structure of the vehicle via a linkage mechanism that allows the ladder to be moved between a horizontal stored position and a deployed upright position. In the deployed upright state of this foldable ladder, guide sleds and link members absorb forces acting from above (e.g., when a person steps onto the ladder), and provide a self-locking state of the foldable ladder.

### SUMMARY OF THE INVENTION

A disclosed example ladder includes a mount, a frame including a step, an aperture defined in at least one of the mount and the frame, a lug positioned in the aperture to pivotably and translatably connect the mount and the frame, and a plate. The example ladder also includes a saddle positioned to engage the plate to releasably secure the frame to the mount. At least one of the plate and the saddle is carried by the lug. At least one of the aperture and the lug is dimensioned to permit the at least one of the plate and the saddle to pivot and translate relative to another of the at least one of the plate and the saddle.

A disclosed example method for assembling a ladder includes positioning a lug in an aperture of at least one of a mount and a frame to pivotably and translatably connect the mount and the frame. The frame includes a step to support a person. The example method also includes mounting a plate to the lug and positioning a saddle to engage and disengage the plate as the lug translates within the aperture to selectively release and re-secure the ladder in response to an impact with the frame.

### BRIEF DESCRIPTION OF THE DRAWINGS

FIG. 1 illustrates example ladders shown mounted to an example vehicle.

FIG. 2 is a right, front perspective view of an example ladder of FIG. 1.

FIG. 3 is an enlarged, right, front perspective view of the example ladder of FIGS. 1-2 in an example engaged state, shown with an example cover removed.

FIG. 4 is a view similar to FIG. 3, but showing the example ladder of FIGS. 1-3 in an example disengaged state.

FIG. 5 is an enlarged, left, front perspective view of the example ladder of FIGS. 1-4 shown with an upper end plate of a lateral support removed.

FIG. 6 is an exploded left, front perspective view of the example ladder of FIGS. 1-5.

FIG. 7 is a left, front perspective view of an alternative example ladder.

FIG. 8 illustrates an example plate that may be used with examples disclosed herein.

FIG. 9 illustrates an alternative example plate that may be used with examples disclosed herein.

FIG. 10 illustrates another alternative example plate that may be used with examples disclosed herein.

FIG. 11 illustrates yet another alternative example plate that may be used with examples disclosed herein.

FIG. 12 illustrates still another alterative example plate that may be used with examples disclosed herein.

FIG. 13 illustrates an example saddle that may be used with examples disclosed herein.

FIG. 14 illustrates an alternative example saddle that may be used with examples disclosed herein.

FIG. 15 illustrates another alternative example saddle that may be used with examples disclosed herein.

FIG. 16 illustrates still another alternative example saddle that may be used with examples disclosed herein.

FIG. 17 illustrates an example mounting arm that may be used with examples disclosed herein.

FIG. 18 illustrates an alternative example mounting arm that may be used with examples disclosed herein.

FIG. 19 illustrates yet another example mounting arm that may be used with the examples disclosed herein.

FIG. 20 is a flowchart representative of an example method of assembling a ladder.

The figures are not to scale. Wherever possible, the same reference numbers will be used throughout the drawing(s) and accompanying written description to refer to the same or like parts. As used in this patent, stating that any part is positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts. As used herein, the terms “comprising,” “including” and “having” are open-ended. Therefore, a list of one or more parts, steps, etc. introduced by the term “comprising,” the term “including” or the term “having” may include one or more additional parts, steps, etc.

### DETAILED DESCRIPTION

In known heavy machinery vehicles, a ladder is often mounted to the vehicle to provide access and/or a step up to a portion of the vehicle. The ladder can be mounted on the front, a side and/or a back of the vehicle. Such ladders usually extend to a relatively low clearance from the ground so that a person can access a first step of the ladder directly from the ground. These ladders have rigidity and/or strength sufficient to support the weight of a person. The combination of the low clearance to the ground and the required rigidity and strength of the ladder can sometimes result in damage to the ladder when, for example, the ladder is subjected to an impact with an object, the ground or any other structure as the vehicle is moved.

For example, ladders of industrial vehicles are often subject to impacts with berms, the ground and/or objects (e.g., low clearance objects such as rocks, piles of gravel and/or dirt, etc.) on or close to the ground. For instance, a ladder may impact a berm during a loading or unloading operation. Regardless of the cause of the impact, such an impact can sometimes bend or break known ladders, thereby necessitating replacement and/or repair. Replacement or repair may result in servicing costs (e.g., part replacement, labor costs associated with repair) and/or costs associated with downtime of the vehicles due to the servicing process.

Ladders which may be mounted to vehicles (e.g., mining vehicles, trucks, construction machinery, farm machinery, steel mill equipment, etc.) are disclosed herein. Example ladders disclosed herein possess sufficient strength and/or rigidity to support the weight of a person and yet are able to respond to an impact with an object in the environment of use without damage. To this end, example ladders disclosed herein are secured to a vehicle such that the ladder locks into a usable secured position when a person steps onto the ladder and displaces (e.g., translates and/or pivots) in response to an impact (e.g., a collision between the ladder and a structure in the environment).

As used herein, the term “disengaged” is defined to include complete separation of two parts and relative movement (e.g., slipping) between two parts which remain in some level of contact. For example, portions of interfacing gear teeth are considered disengaged even though they may maintain some level of contact while the interfacing gear teeth are able to move (e.g., slip) relative to one another.

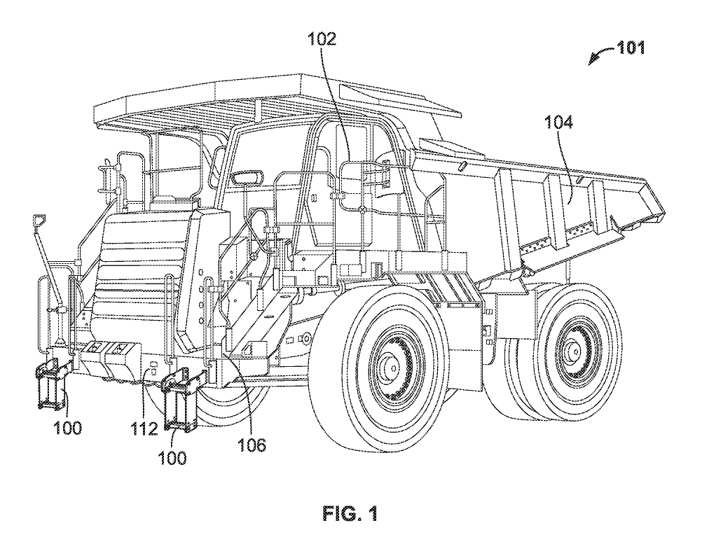

FIG. 1 illustrates example ladders 100 in an example environment of use. In particular, FIG. 1 illustrates two example ladders (a first ladder and a second ladder 100) mounted to an example vehicle 101. The example vehicle 101 can be any type of vehicle for any type of application (e.g., a truck, mining vehicle, construction vehicle, farm equipment, utility vehicle, steel mill equipment, etc.). The example vehicle 101 of FIG. 1 includes a cab 102, a payload storage 104 and a platform (e.g., a personnel loading platform) 106. In the illustrated example of FIG. 1, the first ladder 100 and the second ladder 100 are mounted to a front surface 112 of the example vehicle 101. However, either or both ladder(s) could, additionally or alternatively, be mounted to a side or rear of the vehicle 101. In the illustrated example, the first and second ladders 100 are identical. Although two ladders are shown in FIG. 1, any number of ladders may be present (e.g., 1, 3, 4 or more).

In the example of FIG. 1, the first and second ladders 100 are used by personnel to climb from the ground to the platform 106 to, for example, access the cab 102. The first and the second ladders 100 of the illustrated example are intended to support the weight of an individual. Therefore, the ladders 100 are constructed of material having sufficient rigidity and/or strength to support such weight. In the example of FIG. 1, the first and the second ladders 100 extend to a relatively low clearance above the ground. As a result, the first and/or the second ladder 100 can impact the ground (e.g., berms) and/or objects on the ground (e.g., rocks, etc.) as the vehicle 101 moves. To avoid damage from such impacts, the first and the second ladders 100 of the illustrated example are at least partially displaceable (e.g., translatable and/or pivotable) in response to a collision or other impact with an object in the environment without separating from the vehicle 101. In the illustrated example, the ladders 100 remain attached to the vehicle and return to a locked/secured position to support a person stepping onto the ladder after the force associated with the collision and/or impact is removed.

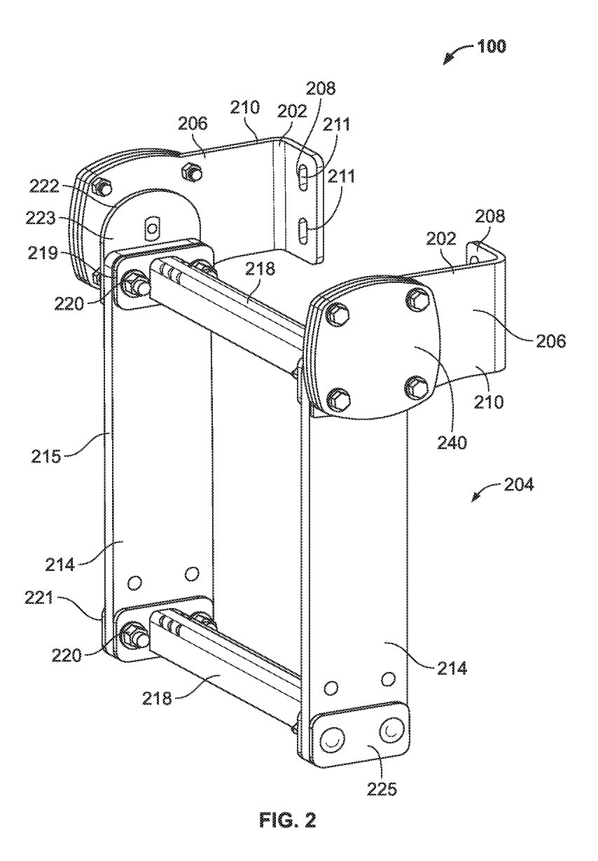

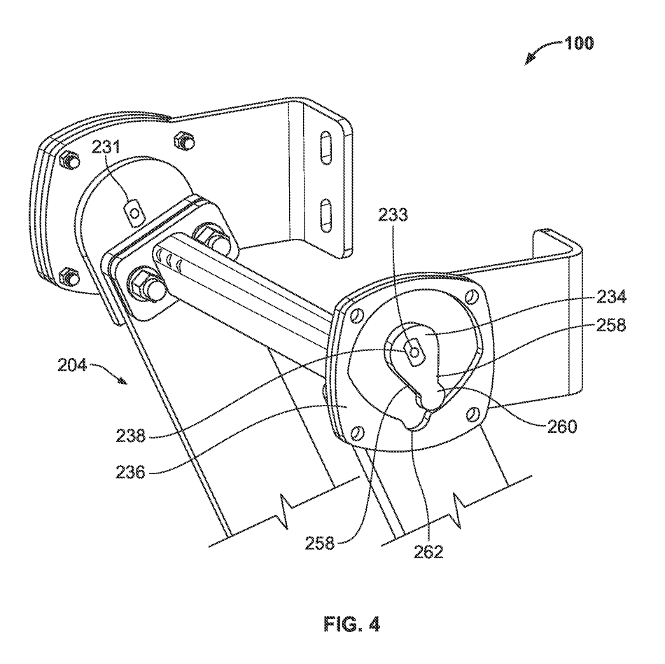

FIG. 2 is a right, front perspective view of the example ladder 100 of FIG. 1. As noted above, the ladders 100 of FIG. 1 are identical. Therefore, FIG. 2 illustrates both of the ladders 100 of FIG. 1. The example ladder 100 of FIGS. 1 and 2 is a breakaway ladder having one or more engaged states and one or more disengaged states. In the example of FIG. 2, the ladder 100 is shown in an example engaged state. An example disengaged state of the ladder 100 is shown below in connection with FIG. 4.

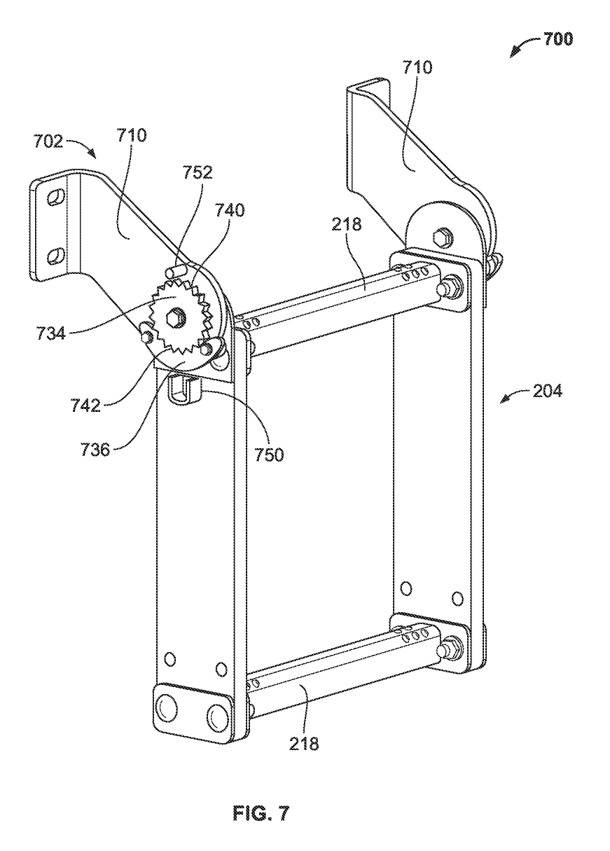

The example ladder 100 includes means for securing the ladder 100 to a vehicle (such as a vehicle 101) and support means for supporting a person. In the example of FIG. 2, the securing means is implemented by a mount 202 and the support means is implemented by a frame 204. The mount 202 of the illustrated example includes two spaced apart mounting brackets 206. In this example, each mounting bracket 206 is an L-shaped bracket having a flange 208 and a support arm 210. Each of the flanges 208 of the illustrated example defines through holes 211 to receive mechanical fasteners (e.g., bolts or the like) to secure the corresponding bracket 206 to the vehicle 101. Although, the flanges 208 are shown inwardly directed in the examples of FIGS. 1-6, the flanges 208 can alternatively be outwardly directed as shown in the example of FIG. 7. When secured to the vehicle 101, the support arms 210 project outwardly away from the vehicle 101.

In the illustrated example of FIGS. 1-6, the frame 204 includes lateral supports 214 joined by one or more horizontal steps 218. Although two steps 218 are shown in the examples of FIGS. 1-6, the frame 204 can include any number of steps 218 (e.g., one step, two steps, three steps, etc.). The lateral supports 214 of the illustrated example are implemented by side plates 215 and upper end plates 223. The lateral supports 214 may be at least partially composed of rubber, for example. In the illustrated example, the steps 218 are implemented by rigid tubes or bars and, thus, have a rounded profile. However, the steps 218 may alternatively be implemented by plates or platforms and, thus, may have a profile of any other shape (e.g., rectangular, square, etc.).

In the example of FIGS. 1-6, the opposite ends of the uppermost step 218 are welded or otherwise secured to a flange 219. The flanges 219 provide structure to couple the opposite ends of the uppermost step 218 to respective ones of the lateral supports 214. In particular, the uppermost step 218 of this example is secured at its opposite ends to the upper end plates 223 and the side plates 215 of the lateral supports 214 via the flanges 219 and mechanical fasteners 220. In particular, apertures defined in the flanges 219 of the uppermost step 218, in the side plates 215, and the in the upper end plates 223 receive the respective fasteners 220 to join the lateral supports 214, the end plates 223 and the uppermost step 218. Other step(s) are coupled to the lateral supports 214 in a manner similar to the way in which the uppermost step 218 is coupled to the lateral supports 214. However, the lower step(s) do not directly connect to the upper end plates 223 with mechanical fasteners 220. As shown in FIG. 2, outer flanges 221, 225 are used on the outer side of the lateral support 214 adjacent the lower step 218 to prevent tightening of the lower mechanical fasteners 220 from abrading the lateral support 214 (e.g., to prevent the mechanical fasteners 220 from wearing or penetrating their respective lateral support 214) and/or to distribute forces around the mechanical fasteners 220. Although mechanical fasteners are used to couple the lateral supports and the steps 218, the steps 218 and/or the lateral supports 214 may be coupled directly or indirectly in any manner with any kind of fastener(s) (e.g., a chemical fastener, glue, a tongue and groove connection, threading, etc.). Together, the lateral supports 214 and the steps 218 form the frame 204 on which a person can stand or climb. Thus, the material selected for the components of the frame 204 (e.g., the lateral supports 214, the steps 218, the fasteners 220, etc.) are selected to ensure the frame 204 has sufficient strength and rigidity to support an appropriate amount of weight (e.g., 300-600 lbs.).

In the illustrated example, the frame 204 is cantilevered from the arms 210. In particular, upper ends 222 of the lateral supports 214 of the frame 204 are pivotably mounted to respective ones of the support arms 210. In the illustrated example, the upper ends 222 of the lateral supports 214 are implemented by the upper end plates 223 which are coupled to the side plates 215 and the steps 218 via the mechanical fasteners 220 as explained above. In the illustrated example, the support arms 210 have strength sufficient to suspend the frame 204 a distance away (e.g., 2-12 inches) from the vehicle 101 to facilitate a person stepping on the steps 218 without causing the support arms 210 to bend.

In the illustrated example, the mount 202 is implemented by two substantially identical support arms 210 and the frame 204 is implemented by a symmetrical structure with two opposed lateral supports 214. The lateral supports 214 of the frame 204 are each joined to a respective one of the support arms 210 in substantially a same manner. For ease of discussion, the following description is directed to an example manner of connecting one of the lateral supports 214 to one of the support arms 210. That discussion applies equally well to both lateral supports 214 and both support arms 210. Therefore, in the interest of brevity, that discussion will not be repeated. Instead, it will be understood that the following description of the connection of one of the lateral supports 214 to one of the support arms 210 applies to both connections of the frame 204 to the mount 202.

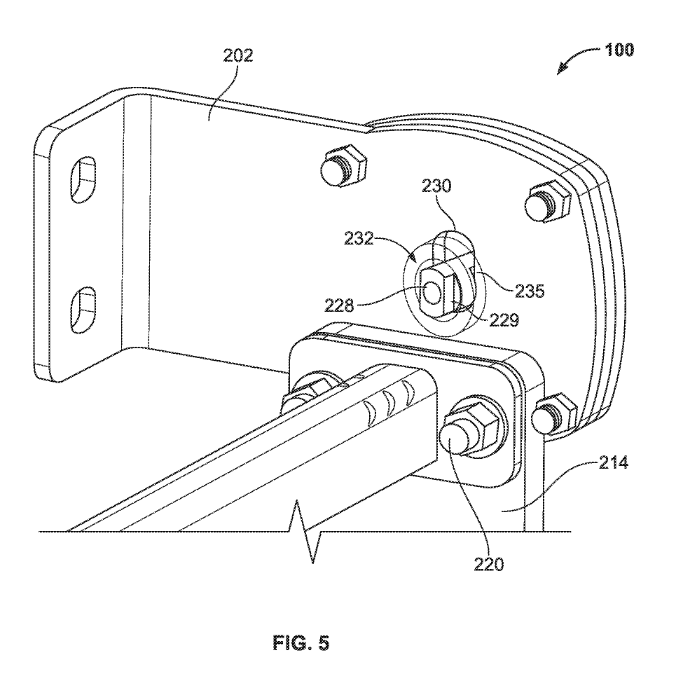

In order to pivotably couple the frame 204 to the mount 202 while permitting vertical displacement (e.g., translation) between the frame 204 and the mount 202, at least one of the mount 202 and the frame 204 defines an aperture 230 (See FIG. 5). The example aperture 230 shown in FIG. 5 exhibits a straight slot profile (e.g., an opening whose sides are substantially parallel at a fixed distance from one another except for, in the illustrated example, at the rounded top and bottom of the opening). However, the example aperture 230 may alternatively have a tear-drop profile, a keyhole profile, an oval profile, a round shape or any other appropriate shape.

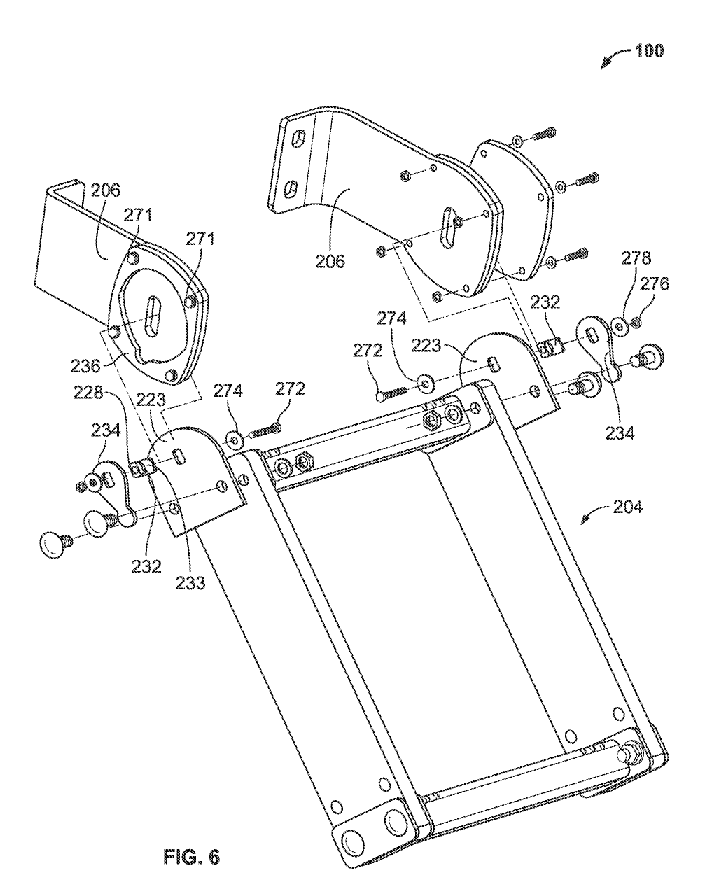

To translatably and pivotably join the frame 204 and the mount 202, at least one of the mount 202 and the frame 204 includes a lug 232. As shown in FIG. 5, the example lug 232 is positioned in the aperture 230 to connect the mount 202 and the frame 204 (To provide a better view, the upper end plate 223 of the lateral support 214 is removed in FIG. 5). As can be seen in the example view of FIG. 5, the lug 232 has a cross-sectional shape (e.g., a cross-sectional diameter) that permits the lug 232 to both translate (e.g., move up and down, backward and/or forward) and rotate within the aperture 230. The example lug 232 of FIG. 5 also has a first keyed end 229 (e.g., has a non-circular cross-section) to be received by an aperture 231 of one of the upper end plates 223 (See FIG. 4) to rotationally secure the inner keyed end 229 of the lug 232 to one of the upper end plates 223. In the example of FIG. 5, the lug 232 has a through hole 228 to receive a mechanical fastener 272. The mechanical fastener 272 passes through the through hole 228 and threadably engages a nut 276 (see FIG. 6) to secure the respective upper end plate 223, the lug 232 and the plate 234 (discussed below) together. In the example of FIG. 6, a washer 274 is employed between a head of the fastener 272 and the upper end plate 223 to provide an enlarged mechanical seat and ensure the upper end plate 223 does not separate from the lug 232. Similarly, a washer 278 of the illustrated example provides an enlarged mechanical seat between the nut 276 and the plate 234. In some other examples, the lug 232 does not include the through hole 228, but instead has blind threaded holes on opposite ends of the lug 232 to receive fasteners to couple the lug 232, the upper end plate 223 and the plate 234 together.

As shown in FIG. 4, an outside end of the example lug 232 terminates in a second keyed end 233. As mentioned above, the lug 232 is free to move within the aperture 230 while maintaining a connection between the mount 202 and the frame 204 (See FIG. 5). The lug 232 penetrates the aperture 230 and a respective one of the upper end plates 223 to pivotably connect a respective one of the support arms 210 to a respective one of the lateral supports 214. Because the lug 232 is able to translate and rotate within the aperture 230, the frame 204 of the illustrated example can translate and pivot relative to the mount 202. As can be seen in FIG. 5, in some examples, a spacer 235 (e.g., a washer) separates and/or maintains a distance between the upper end plate 223 and the corresponding support arm 210.

For the purpose of automatically defining one or more engaged states between the support means (e.g., the frame 204) and the securing means (e.g., the mount 202), the example ladder 100 of FIGS. 1-6 is provided with engaging means. The engaging means of the illustrated example automatically re-engages the support means (e.g., the frame 204) and the securing means (e.g., the mount 202) in an engaged position after application and removal of a force sufficient to displace the support means from the securing means. When engaged, the engaging means prevents rotation of the support means relative to the securing means. However, in some examples, the engaging means does not prevent translation of the support means relative to the securing means in at least one direction (e.g., upward, forward (e.g., away from the vehicle(s)), backward (e.g., toward the vehicle(s)), etc.). As a result, the support means can disengage the securing means in response to an impact or the like.

In the example of FIGS. 1-6, the engaging means is implemented by one or more plates 234 and one or more saddles 236. In the illustrated example, two plates 234 and two saddles 236 are employed. One pair of a plate 234 and a saddle 236 is mounted on each side of the frame 204. In the example of FIGS. 1-6, each saddle 236 is positioned to engage the corresponding plate 234 to releasably secure the frame 204 to the mount 202. At least one of the plate 234 and the saddle 236 in a plate/saddle pair is carried by a respective lug 232. Because, as explained above, the lug 232 and its corresponding aperture 230 are dimensioned to permit translation and pivoting of the lug 232 within the aperture 230, at least one of the plate 234 and the saddle 236 is able to move (e.g., translate and/or pivot) relative to the other of the plate 234 and the saddle 236 in a plate/saddle pair. As a result, the frame 204 can translate and/or pivot relative to the mount 202.

An example manner of implementing a plate/saddle pair will now be described. Because each pair of a plate 234 and a saddle 236 is substantially identical and operates in substantially the same way, in the interest of brevity only one such pair will be discussed in the following. It will be understood, however, that the following description applies equally well to both plate/saddle pairs 234, 236 shown in the example of FIGS. 1-6.

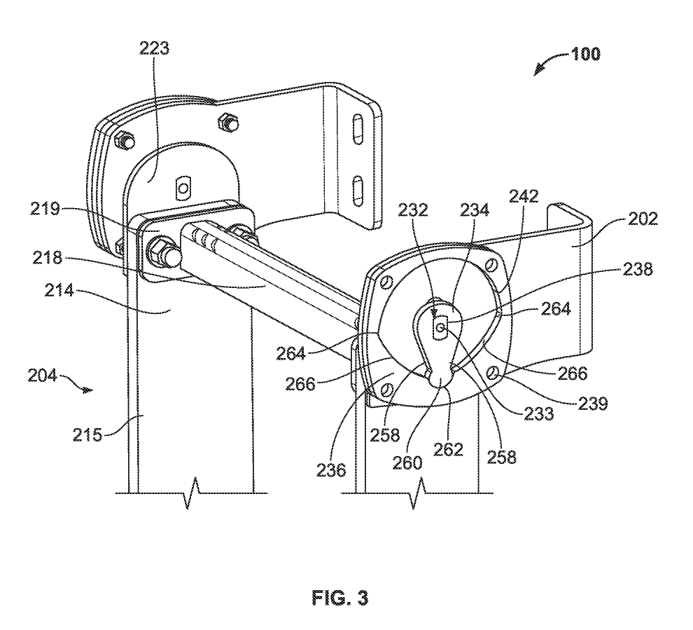

In the example of FIGS. 1-6, the plate 234 is implemented by a rotatable cam follower. As shown in FIG. 4, the rotatable cam follower 234 is a contoured structure (e.g., a plate with a round contoured profile) exhibiting an inverted keyhole shape. Thus, the cam follower 234 of the example has an upper rounded part and a lower elongated part. The lower elongated part is defined by inwardly facing side contours 258 that terminate in a rounded interfacing tip 260. A center of the plate 234 defines an aperture (e.g., a keyed aperture) 238 which is dimensioned (e.g., has a corresponding diameter) to be secured on the keyed outer end 233 of the respective lug 232 (See FIG. 3). In this example, the aperture 238 of the plate 234 closely matches the dimensions of the keyed end 233 of the lug 232 such that there is no intentional movement between the plate 234 and the lug 232. Instead, the plate 234 and the lug 232 translate and pivot together.

In the example of FIGS. 1-6, the saddle 236 is implemented by a contoured cam profile aperture 242 (See FIG. 3). The saddle 236 is secured to the support arms 210 of the mount 202 via mechanical fasteners 271 (See FIG. 6) received at apertures 239 (See FIG. 3) of the saddle 236. While the example contoured aperture 242 shown in FIG. 3 has an iris-like profile in this example, any appropriate shape and/or contour may be used to guide the plate 234 relative to the saddle 236. Some example profiles of the contoured aperture 242 include, but are not limited to, round contours, wave contours, tetrahedral shapes, trapezoidal shapes, polygons, etc. In some such examples, the plate 234 can mate with the saddle 236 in several different orientations. In some such examples, the interfacing tip 260 may contact and lockingly engage different vertices 264 of the contoured aperture 242 as the plate 234 rotates relative to the saddle 236. However, in the example of FIGS. 1-6, the saddle 236 defines a central detent or groove (e.g., a notch) 262 that is dimensioned to receive the interfacing tip 260 of the plate 234 to secure the plate 234 (and, thus, the lug 232 and the frame 204) against rotation.

The engaging means of the example of FIGS. 1-6 defines one engaged position of the frame 204 relative to the mount 202. Furthermore, the contoured cam profile aperture 242 of the saddle 236 is smooth and tapers towards the central groove 262. Therefore, the contoured aperture 242 of the saddle 236 provides cam surfaces to guide the interfacing tip 260 of the cam follower plate 234 toward the central groove 262 after an impact that separates the plate 234 from the groove 262. As a result, the plate 234 and the saddle 236 define a locking interface to secure the frame 204 in least one angular position relative to the mount 202. When the plate 234 is engaged with the groove 262 of the saddle 236, the frame 204 is locked in a generally vertical orientation from the ground and/or relative to the vehicle 101. A person stepping or climbing onto any of the steps 218 applies a downward force to the lugs 232 within their respective apertures 230, thereby causing the interfacing tips 260 of the respective plates 234 to engage a respective one of the grooves 262 of the contoured aperture 242. This engagement rigidly secures the frame 204 to the mount 202 to prevent both rotational and translational motion while a person is stepping or standing on the ladder 100.

As mentioned above, the lugs 232 are structured to translate (e.g., in a generally vertical direction) and pivot within their respective apertures 230. Because the plates 234 are fixed to respective ends of the lugs 232, the plates 234 move (e.g., rotate and translate) with the lugs 232. Therefore, when a sufficient force is applied to the frame 204 (e.g., when a vehicle 101 carrying the ladder 100 moves such that the frame 204 strikes an object in the environment), the lugs 232 and their corresponding plates 234 can translate and/or rotate. Such movement causes the plates 234 to at least partially separate from their respective saddles 236. As a result, the frame 204 can move upward and/or rotate out of the path of the object to reduce the likelihood of the frame 204 (or a portion thereof) being broken, bent or otherwise damaged by the impact. The degree to which the frame 204 is permitted to move (e.g., translate in any direction and/or pivot) is dependent on the sizes of the aperture 230 and the lug 232.

As shown in FIG. 4, the example ladder 100 is in a disengaged state when the plate 234 and/or the interface tip 260 disengages from the groove 262 of the saddle 236. In such an example disengaged state, an upward force has caused a displacement of the frame 204 (e.g., an upward, backward, and/or forward translation and/or pivoting displacement caused by an impact of the ladder 100 and/or the frame 204 with the ground, an object, or another structure). The resulting movement of the frame 204 causes at least one of the plates 234 to displace relative to one of the respective saddles 236, thereby causing the respective interfacing tip 260 of the displaced plate 234 to disengage from (e.g., to displace upward and away from) the respective groove 262 of the saddle 236. As a result, the plate 234 and the frame 204 are free to rotate relative to the mount 202. The frame 204 is shown angled relative to the mount 202 in the example view of FIG. 4.

After the force is removed from the frame 204, the plate 234 will move downward to reengage its saddle 236 to again secure the frame 204 in a fixed position (e.g., a fixed vertical position) relative to the mount 202. If movement of the frame 204 causes the plates 234 to pivot out of alignment with their respective grooves 262, the contoured surfaces of the saddle 236 will guide the interfacing tips 260 back toward their respective grooves 262 as the plates 234 return downward under the influence of gravity (e.g., after the external force is removed). In particular, the contoured aperture 242 of the illustrated example includes steep angle contours 266 (e.g., defined by the iris-like shape of the aperture 242) that acts as a cam surface to guide the interfacing tip 260 of the plate 234 to move into a default, locked position (See FIG. 3). The interfacing tip 260 is retained/captured within the groove 262 after the frame 204 has translated and/or rotated under the influence of gravity into the default locked position. The frame 204 is locked against rotation when the interfacing tip 260 is secured in the groove 262.

While mechanical fasteners 220, 271, 272 are employed in the above example, any appropriate alternative type of coupling may be used (e.g., rivets, adhesives, welding, etc.). Furthermore, the saddle 236 and/or the plate 234 may be implemented with a heat treated/hardened surface.

As explained above, the plate 234 is able to move into and out of engagement with its saddle 236. As a result, the plate 234 and the saddle 236 create a potential pinch point. To ensure nothing becomes caught between the plate 234 and the contours of the saddle 236, the example ladder 100 of FIGS. 1-6 is provided with a cover 240 (See FIG. 2). In some examples, the fastener 272 is threaded into the lug 232 and is not threaded to a nut 276. In such examples, the plate cover 240 retains the plate 234 from being removed from the lug 232. In some examples, a lubricant is applied to one or more of the plate 234, or the saddle 236 and at least partially retained by the plate cover 240. In some examples, the cover 240 is sealed to the mount 202 via a sealing gasket (e.g., a compressible gasket). In some examples, the cover 240 reduces and/or prevents debris, clothing, hands or other material from interfering with movement of the lugs 232 within the corresponding aperture 230 and/or with movement of the plates 234.

FIG. 7 is a left, front perspective of an alternative example ladder 700. The example ladder 700 of FIG. 7 is similar to the example ladder 100 of FIGS. 1-6. However, in the example of FIG. 7 the engagement means is implemented in a different manner (explained in detail below). In view of these similarities, to avoid redundancy, like structures appearing in both the example ladder 700 of FIG. 7 and in the example ladder 100 of FIGS. 1-6 will not be redescribed here. Instead, the interested reader is referred to the above description for a full and complete discussion of these structures. To facilitate that process, similar structures will be numbered with like reference numbers in the following and the above descriptions.

The example ladder 700 of FIG. 7 includes support means (e.g., the frame 204), securing means (e.g., a mount 702 with support arms 710), and engaging means for automatically re-engaging the securing means with the support means after the application and removal of a force sufficient to disengage the securing means and the support means. In a similar manner to the example ladder 100, the frame 204 of the illustrated example is pivotably coupled to the mount 702.

The engagement means of FIG. 7 includes a plate 734 and a saddle 736. In contrast to the plate 234 described above in connection with FIGS. 2-6, the plate 734 of the example of FIG. 7 is implemented by a toothed gear or wheel. As shown in FIG. 7, the toothed gear or wheel 734 of this example is a circular structure with a circumference including a plurality of teeth 740.

In the example of FIG. 7, the saddle 736 is implemented by an arcuate rack having notches and/or teeth 742 dimensioned to mate with the teeth 740 of the plate 734. As such, the plate 734 can mate with the saddle 736 in several different orientations. As a result, the plate 734 and the saddle 736 define a locking interface to secure the frame 204 at two or more different angular positions relative to the mount 702. When the plate 734 is engaged with the saddle 736 (e.g., the teeth 740 of the plate 734 are engaged in the notches of the teeth 742 of the saddle 736), the frame 204 is locked in one of a plurality of generally vertical orientations from the ground (e.g., vertical (i.e., substantially perpendicular to ground), +2 degrees from vertical, −2 degrees from vertical, etc.). When a person steps on the ladder 700 (e.g., places some or all of their weight on a step 218 of the frame 204), the applied force ensures the teeth 740 of the plate 734 enter the notches of the teeth 742 of the saddle 736 to thereby firmly lock the frame 204 and the mount 702 against rotation.

In this example, depending on the amount of applied force and the translation of the lug 232 in an aperture (e.g., an aperture similar to the aperture 230) of the support arm 710, the plate 734 and the saddle 736 may remain partially in contact even in a disengaged state. For example, the teeth 740 of the plate 734 and the teeth 742 of the saddle 736 may contact, slide and move past one another without completely separating during some state(s) of disengagement of the plate 734 from the saddle 736.

In some examples, in order to lock the frame 204 in a stowed position in which the frame 204 is rotated upward and away from the ground, at least one of the lateral supports 214 of the frame 204 may have a hook 750. In the example of FIG. 7, the cup-shaped hook 750 is coupled (e.g., welded, chemically coupled, etc.) to the lateral support 214. In such examples, at least one of the support arms 210 of the mount 702 includes a corresponding pin 752 to capture the hook 750 with the frame 204 rotated upward and/or displaced relative to the mount 702. The pin 752 may be coupled to the support arm 210 by any appropriate coupling method (e.g., friction welded, chemically coupled, adhered, etc.) and/or assembled to the support arm 210 (e.g., coupled via a chain, movable as part of a spring-loaded assembly).

FIG. 8 illustrates an example plate 800 that may be used in examples disclosed herein. The plate 800 of the illustrated example includes a keyed aperture 802 dimensioned to mate with the keyed end 233 of a lug 232. The example plate 800 also includes teeth 806 disposed around its circumference. The teeth 806 of the illustrated example define rounded peaks 808 and corresponding rounded valleys 810. Although not shown in FIG. 8, the saddle 736 of FIG. 7 includes teeth and valleys corresponding to the peak 808 and the valleys 810 of the plate 800. In the example of FIG. 8, the rounded peaks 808 and the rounded valleys 810 facilitate rotation of the plate 800 relative to a corresponding saddle 736 in response to an applied force. In some examples, the rounded peaks 808 and/or the rounded valleys 810 may increase a life (e.g., an operational service time) of the plate 800 and/or the corresponding saddle of the example of FIG. 8 by reducing the amount of force required for rotation. The example teeth 806 of the example FIG. 8 are angled relative to a defined horizontal reference at an angle 812 denoted by the symbol, θ in FIG. 8. In some examples, the angle 812 ranges from 60 degrees (°) to 90°.

FIG. 9 illustrates an alternative example plate 900 that may be used in examples disclosed herein. The example plate 900 is similar to the plate 800. However, the teeth 902 of the example plate 900 have shallower angles in comparison to the plate 800 of FIG. 8. The plate 900 has relatively deeper teeth and a larger tooth pitch.

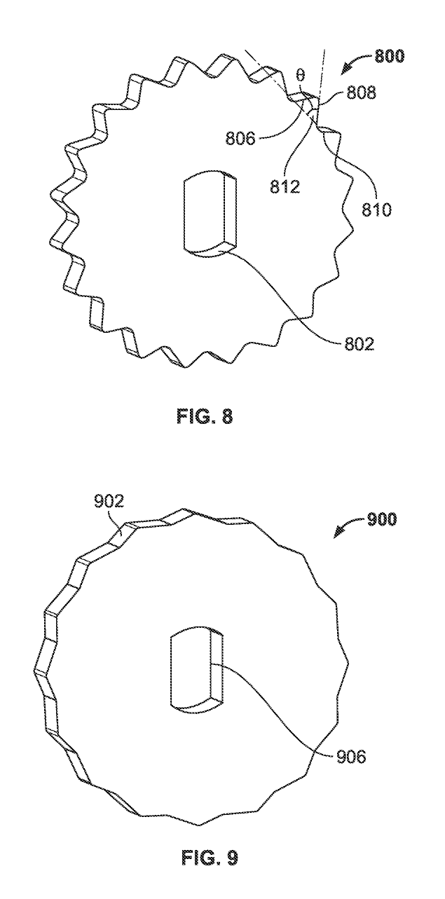

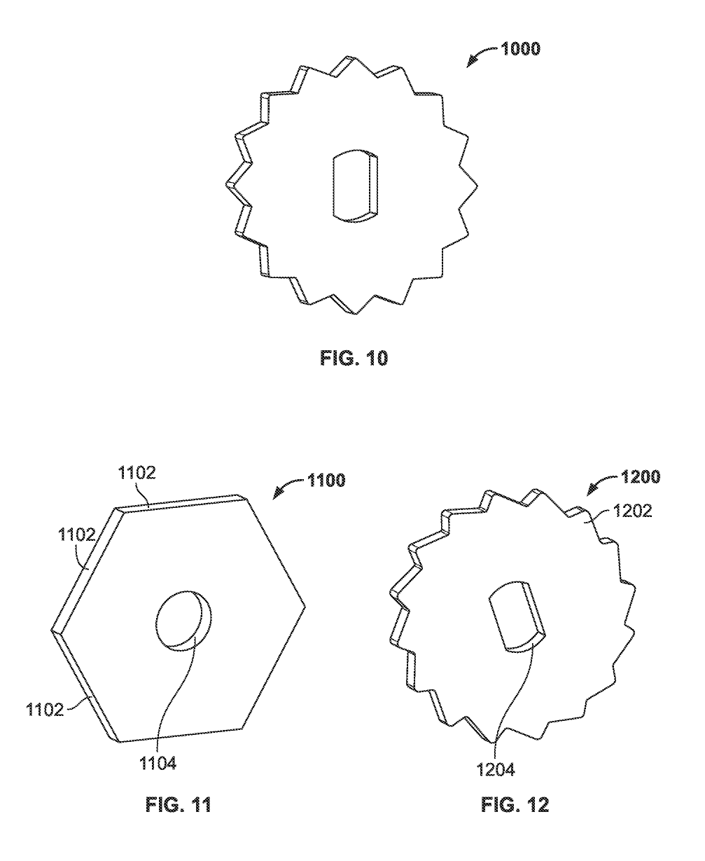

FIG. 10 illustrates another alternative example plate 1000 that may be used in examples disclosed herein. The example plate 1000 of FIG. 10 exhibits sharper outer edges than either example plate 800 of FIG. 8 or the example plate 900 of FIG. 9.

FIG. 11 illustrates yet another alternative example plate 1100 that may be used in examples disclosed herein. The example plate 1100 includes a hexagonal shape/profile. The example plate 1100 includes relatively flat outer surfaces 1102 to engage a corresponding saddle 236, 736. In this example, the plate 1100 also includes an aperture 1104, which is circular, and does not exhibit a keyed shape. The aperture 1104 receives an end of a lug 232 as explained above. Although this aperture is round, a keyed shape may alternatively be used. While an overall hexagon shape/profile is shown in the example of FIG. 11, any appropriate shape/profile may be used such as a triangle, a square, a pentagon, a heptagon, an octagon, or any other polygon. In some examples, the relative flatness of the surfaces 1102 can be used to secure the plate 1100 to a respective saddle at multiple angular positions/rotations.

FIG. 12 illustrates still another alternative example plate 1200 that may be used in examples disclosed herein. The example plate 1200 includes teeth 1202, which have asymmetric profiles. The example plate 1200 of FIG. 12 also includes a keyed aperture 1204 to mate with a lug 232. In this example, the asymmetric teeth 1202 have sides of different angular spacing to cause a force needed to rotate the plate 1200 in a first direction to be greater than a force need to rotate the plate 1200 in the opposite direction assuming contact between the plate 1200 and a saddle 236. This may be useful, for example, if rotation toward the vehicle 101 is preferred to rotation away from the vehicle 101.

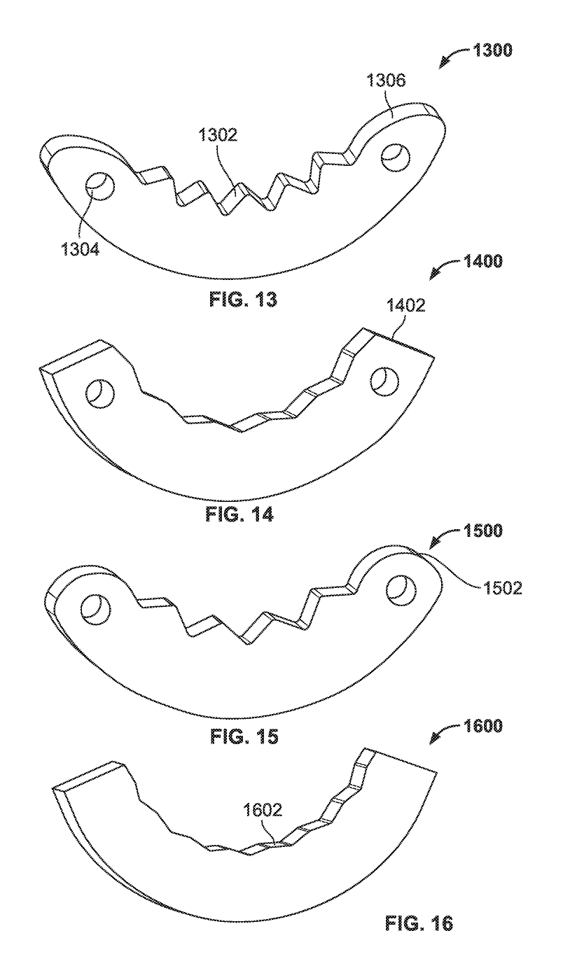

FIG. 13 illustrates an example saddle 1300 with teeth 1302 having relatively sharp edges (e.g., angular cuts, straight angle cuts, etc.). The saddle 1300 includes mounting apertures 1304 to receive mechanical fasteners to fasten the saddle 1300 to a support arm 210, 710. In this example, the saddle 1300 includes rounded surfaces 1306 to alleviate stresses that may be encountered from surface/contact interactions with a plate 234, 800 as the plate rotates and/or engages the saddle 1300. In contrast to the example saddle 1300, the example saddle 1400 of FIG. 14 has straight edges 1402 instead of the rounded surfaces 1306. The example saddle 1500 shown in FIG. 15 is similar to the saddle 1300, but has circular edges 1502. The example saddles of FIGS. 13-15 include mounting apertures to facilitate mounting the saddle to a support arm 210 via mechanical fasteners.

FIG. 16 illustrates still another alternative example saddle 1600 that may be used in examples disclosed herein. The saddle 1600 of the illustrated example includes relatively straight contours 1602. In contrast to the examples of FIGS. 13-15, the example saddle 1600 does not include mounting apertures. In some examples, the saddle 1600 is integral with a support arm 210, and/or integrally assembled to a component assembled to a support arm 210. In some examples, the saddle 1600 may be coupled to a respective support arm via mechanical fasteners.

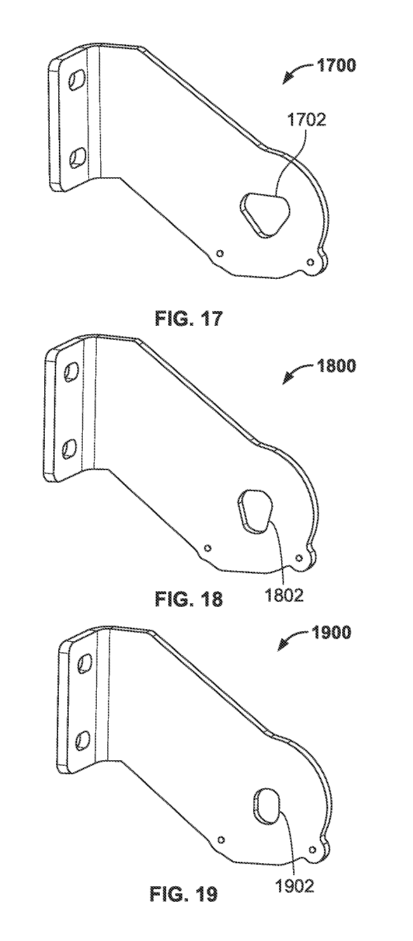

FIG. 17 illustrates an example support arm 1700 that maybe used in examples disclosed herein. The example support arm 1700 has a tear-drop shaped aperture 1702 that has a relatively wide overall width in an upward direction, but narrows in a downward direction to direct a lug within the aperture 1702 as it moves downward. The example support arm 1800 of FIG. 18 is similar to the support arm 1700, but has a narrower width aperture 1802. In contrast to both the support arm 1700 and support arm 1800, the support arm 1900 of FIG. 19 has a straight slot aperture 1902.

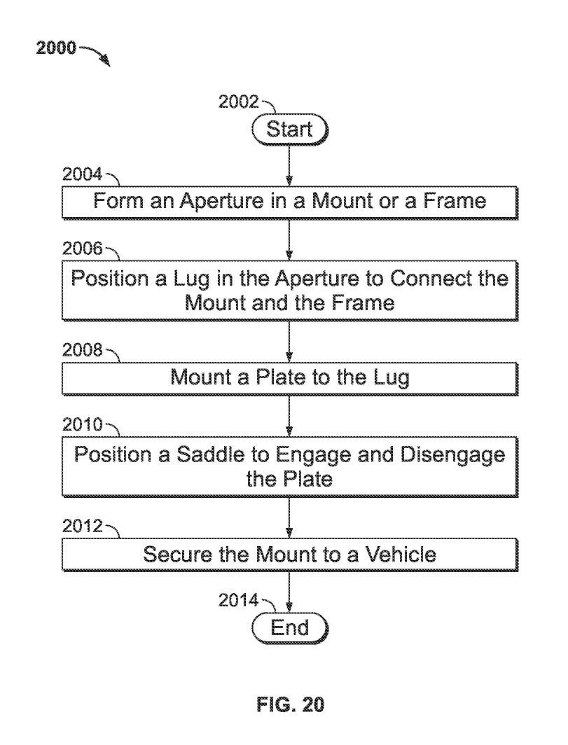

FIG. 20 is a flowchart 2000 representative of an example method for assembling a ladder. The example method begins at block 2002 where an aperture (e.g., the aperture 230) is formed in one or more of a mount (e.g., the support arms 210, 710, 1700, 1800, or 1900) or a frame (e.g., the frame 204) (block 2004). In other examples, the aperture is pre-formed in one or more of the mount or the frame. Next, a lug (e.g., the lug 232) of the illustrated example is positioned in the aperture of at least one of the mount 202, 702 and the frame 204 to pivotably connect the mount and the frame (block 2006).

In the example of FIG. 20, a plate (e.g., the plate 234, 734, 900, 1000, 1100, or 1200) is mounted to the lug (block 2008). A saddle (e.g., the saddle 236, 736, 1300, 1400, 1500, or 1600) is then positioned to engage and disengage the plate as the lug moves within the aperture to selectively release the ladder in response to an impact with the frame (block 2010). For example, the saddle may be affixed to a support arm 210 (e.g., with mechanical fasteners or any other mechanical connection). Next, in some examples, the mount is secured to a vehicle (block 2012). The example method of FIG. 20 then ends (block 2014).

From the foregoing, it will be appreciated that ladders and methods of manufacturing ladders have been disclosed which support the weight of a person while avoiding potential damage from an impact with an object in the environment, thereby avoiding expenses related to replacement, service, downtime and/or associated labor costs. While example ladders shown herein may be advantageously mounted to vehicles, example ladders disclosed herein may be used on any other appropriate structure, including stationary structures. A ladder on a stationary structure may need to rotate and/or translate in response to an applied force (e.g., when struck by a person, a forklift, etc.).

### INDUSTRIAL APPLICABILITY

Example ladders disclosed herein may be used, in places that are prone to impacts including, for example, ladders on mobile equipment such as mining vehicles, construction equipment, farming equipment, trucks, utility vehicles, steel factory equipment construction vehicles, trucks, pickup trucks, etc. Example ladders disclosed herein may alternatively be mounted to a stationary structure, in which the ladder may be subject to impact from moving machinery (e.g., from a forklift in an industrial site, a warehouse, etc.).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A ladder comprising:
a mount;
a frame including a step;
an aperture defined in at least one of the mount and the frame;
a lug positioned in the aperture to pivotably and translatably connect the mount and the frame;
a plate; and
a saddle positioned to engage the plate to releasably secure the frame to the mount, at least one of the plate and the saddle carried by the lug, and at least one of the aperture and the lug dimensioned to permit the at least one of the plate and the saddle to pivot and translate relative to another of the at least one of the plate and the saddle.

2. The ladder as defined in claim 1, wherein the plate includes a cam follower and the saddle includes a cam.

3. The ladder as defined in claim 1, wherein the plate includes a tooth.

4. The ladder as defined in claim 3, wherein the tooth exhibits an asymmetric profile.

5. The ladder as defined in claim 1, wherein the plate is a toothed gear.

6. The ladder as defined in claim 5, wherein the saddle is a rack having teeth to mate with the toothed gear.

7. The ladder as defined in claim 1, wherein the frame is to pivot relative to the mount in response to a force.

8. The ladder as defined in claim 1, wherein the aperture has a profile that exhibits at least one of a tear-drop, a keyhole, a slot, an oval or a round shape.

9. The ladder as defined in claim 1, wherein the plate and the saddle define a locking interface to secure the frame at an angular position relative to the mount.

10. The ladder as defined in claim 1, wherein the plate has a round contoured profile.

11. The ladder as defined in claim 1, wherein a cross-sectional diameter of the lug is smaller than a corresponding diameter of the aperture.

12. The ladder as defined in claim 1, wherein the mount is secured to a vehicle.

13. The ladder as defined in claim 1, wherein weight on the ladder causes the frame to be locked against rotating relative to the mount.

14. The ladder as defined in claim 1, wherein the saddle includes a detent to receive a portion of the plate to lock the frame against rotating relative to the mount.

15. A ladder comprising:
securing means for securing the ladder to a vehicle;
support means for supporting a person; and
engaging means for automatically re-engaging the securing means with the support means after application and removal of a force sufficient to disengage the securing means and the support means.

16. The ladder as defined in claim 15, wherein, when engaged, the engaging means prevents rotation of the support means relative with the securing means.

17. The ladder as defined in claim 15, wherein weight on the support means causes the support means to be locked against rotating relative to the securing means.

18. A method for assembling a ladder comprising:
positioning a lug in an aperture of at least one of a mount and a frame to pivotably and translatably connect the mount and the frame, the frame including a step to support a person;
mounting a plate to the lug; and
positioning a saddle to engage and disengage the plate as the lug translates within the aperture to selectively release the ladder in response to an impact with the frame.

19. The method as defined in claim 18, further including forming the aperture in the at least one of the mount and the frame.

20. The method as defined in claim 18, further including securing the mount to a vehicle.
